(19) United States
(12) Patent Application Publication
(10) Pub. No.: US 2019/0208394 A1
(43) Pub. Date: Jul. 4, 2019

(54) SYSTEM AND METHOD FOR EMERGENCY MESSAGE TRANSMISSION

(71) Applicant: Fabien Onissah, Perpignan (FR)

(72) Inventor: Fabien Onissah, Perpignan (FR)

(21) Appl. No.: 16/314,206

(22) PCT Filed: Jun. 30, 2017
(86) PCT No.: PCT/EP2017/066377

§ 371 Date: Dec. 28, 2018

(30) Foreign Application Priority Data
Jul. 1, 2016 (FR) 1670360

(51) Int. Cl. H04W 4/90; H04M 1/725; H04W 4/14; H04W 76/50

(52) U.S. Cl. CPC H04W 4/90; H04M 1/72541; H04W 76/50; H04M 1/72552; H04W 4/14

(57) ABSTRACT

The invention relates to a system for transmitting an emergency message, comprising:
a triggering means (2) activated by pressure or contact, and
a mobile application (4) designed to be installed on a mobile device (3) and to cooperate with the trigger means (2), also configured to respond to the activation of the triggering means (2) by transmitting an emergency SMS message to an emergency device (5, 11) via a mobile network, in particular of type GSM, enhanced by:
an emergency relay device (5), and
a call generating device (6) connected to the emergency relay device (5), said call generating device (6) being configured to generate an emergency voice message, corresponding to the emergency SMS message forwarded by the emergency relay device (5), then initiate a phone call to the emergency voice device (8) of an emergency contact, and finally announce said emergency voice message to this emergency contact. The invention also relates to both the method and a kit associated.

The present invention relates to the fields of electronics, information technology, and telecommunications, combined in the context of automated sending of personalized, preferably geolocated, telephone messages, particularly in emergency situations.

Currently, some applications for smartphones can only send SMS (for “Short Message Service”) emergency messages. In addition, rarer applications can also ring phones. Even rarer applications are able to transmit a voice message to the recipient phone.

These applications are very limited because they still have major disadvantages:

Most of the applications of the prior art have to be triggered from the graphical interface of the smartphone only. This implies being able to grab the smartphone, unlock it, search for the application, launch the application and only then trigger the application. In most emergency situations requiring these applications, the user has neither the time nor the opportunity to carry out all these steps before sending an emergency message.

The mobile applications of the prior art which trigger a phone call do not communicate with the solicited contact, which makes such phone call irrelevant or even unnecessary.

Prior art applications that transmit a voice message to the recipient are only efficient with a smartphone connected to the Internet. They are therefore unusable in areas not covered by a mobile Internet network, or by users who do not have a mobile Internet contract, or who exceeded their contracted data capacity. Moreover, as emergencies are basically not predictable, the smartphone using these applications must stay constantly connected to the Internet, which is energy consuming.

The prior art mobile applications that send emergency SMS messages generally use SMS services over the Internet. Therefore, they can only solicit personal contacts from the user (friends, relatives or others), but can't contact professional emergency services, which are the most available, responsive and qualified to respond to a serious emergency. Indeed, emergency services that might be contacted by SMS, usually reserved for people with speech or language impairment, can not be solicited by SMS over the Internet. The reason for this is that SMS over the Internet is provided by servers usually located hundreds of kilometers away from the user, even possibly, in another country. SMS messages sent to the emergency number would thus be routed to the closest emergency services to such servers. These SMS messages would therefore be addressed to emergency services located hundreds of kilometers from the user, possibly in a different country.

Thus, such emergency SMS messages sent to emergency services might possibly, at best, be transferred back to the appropriate region or country, then arrive late. At worst, they could even be lost. Particularly, they may even not be understood by the receiving service, should it be located in a foreign country.

The object of the present invention is to propose an emergency message transmission system allowing a rapid transmission of a relevant emergency message, also more efficient in coverage and response time, also less expensive in use and acquisition, also less energy consuming than alternatives in the prior art.

To achieve this, the invention proposed consists of an emergency message transmission system comprising:
A triggering means that can be activated by pressure or by contact
A mobile application, designed to be installed on a mobile device and cooperating with the triggering means, configured to transmit, in response to an activation of the triggering means, an emergency SMS message via a mobile network, in particular GSM, to an emergency device.

Advantageously, the emergency message transmission system is triggered quickly by contact or by pressure and uses a mobile network that does not require any Internet connectivity of the mobile phone of the user, which allows the system to cover much larger areas than the mobile Internet, and makes it less expensive and less energy consuming.

Especially, the system further comprises an emergency relay device and a call generating device connected to the emergency relay device, the call generating device being configured to first produce an emergency voice message corresponding to the data of the emergency SMS message relayed by the emergency relay device, then initiate a phone call to the telephone line of an emergency contact, and finally announce said emergency voice message to the said contact.

Advantageously, the call generating device allows to have a device dedicated to the synthesis of voice messages with a specific storage space, without having to use the resources of the mobile device.

According to other aspects taken separately or combined in any technically feasible combination:
the mobile application comprises a geolocation module and the emergency SMS message comprises geolocation data; and or
the SMS emergency message includes personal data; and or
the mobile application comprises a module for defining said emergency device phone number; and or
the mobile application includes a module for defining an emergency voice device phone line number; and or
the triggering means comprises a trigger device, connectable, in particular via Bluetooth, to the mobile device comprising the mobile application; and or
the trigger device is activated by powering it up electrically; and or
the mobile application and or the call generating device is configured to convert the geolocation data into a street address;
the triggering means comprises a button included in the graphical interface of the mobile application.

In addition, advantageously, when the trigger device includes an activation power switch, this electrical activation allows the trigger device to contain very few components, thus making it inexpensive and easy to miniaturize, and also to spare energy, as it is almost never powered electrically, except at rare moments of emergency. In addition, users do not have to worry about monitoring and maintaining its battery strength.

The invention further relates to an emergency message transmission kit, comprising a mobile application and a triggering means of a system according to an alternate embodiment of the present invention.

Another object of the present invention concerns a method for transmitting emergency messages by the means of a system according to an embodiment of the present invention, comprising the following steps:
trigger the generation of an emergency message by pressure or contact,
transmit, in response to said triggering step, an emergency SMS message via a mobile network, in particular GSM, to an emergency device.

Advantageously, according to any embodiment of the present invention, the emergency message transmission method is triggered quickly, inexpensively, and is made possible a much larger area than that of any Internet coverage.

According to other aspects taken individually or combined in any technically feasible combination:
the method further comprises a step of geolocating a user and introduce geolocation data into the emergency SMS message; and or
the method further comprises a step of convert the geolocation data into a street address; and or
the method further comprises a step of introducing personal data into the emergency SMS message; and or
the method further comprises the following steps:
   generate an emergency voice message corresponding to the emergency SMS message relayed by the emergency relay device,
   initiate a phone call to the telephone line of the device of an emergency contact, and
   announce the said emergency voice message to said contact through said telephone line.

The invention further relates to a computer program product, in particular a mobile application and or a server application, loadable in the memory of at least one electronic device, in particular a mobile device and or a call generating device, comprising program code portions designed to perform the steps of the method according to an embodiment of the invention.

The invention will be further detailed by the description of non-limiting possible embodiment and on the basis of the appended figures in which:

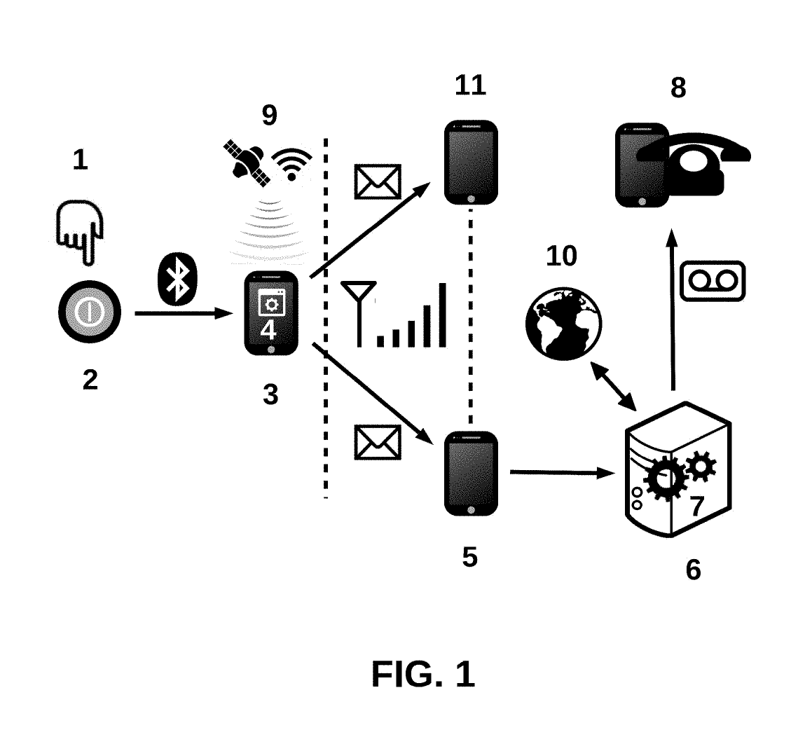

FIG. 1 is a flowchart illustrating the operation of the system according to a first embodiment of the invention, comprising a trigger device;

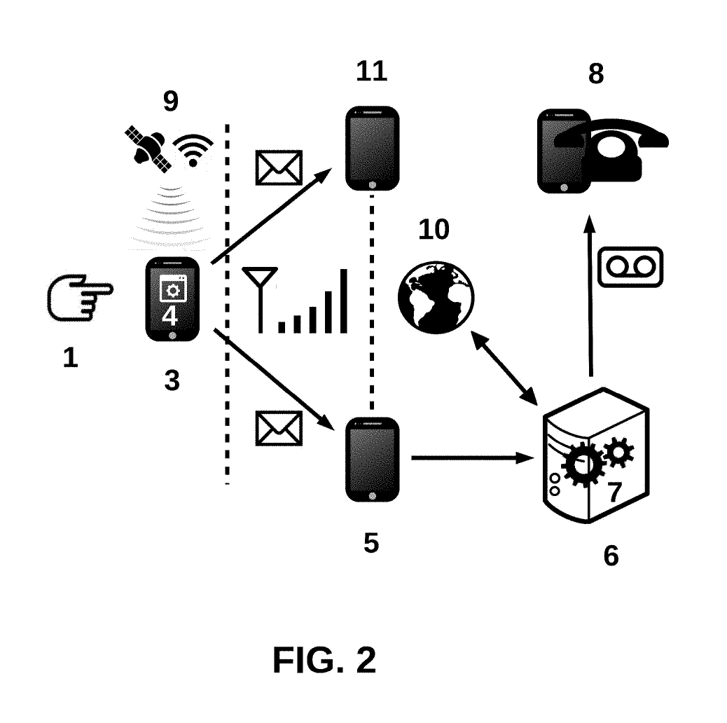

FIG. 2 is a flowchart illustrating the operation of the system according to a second embodiment of the invention;

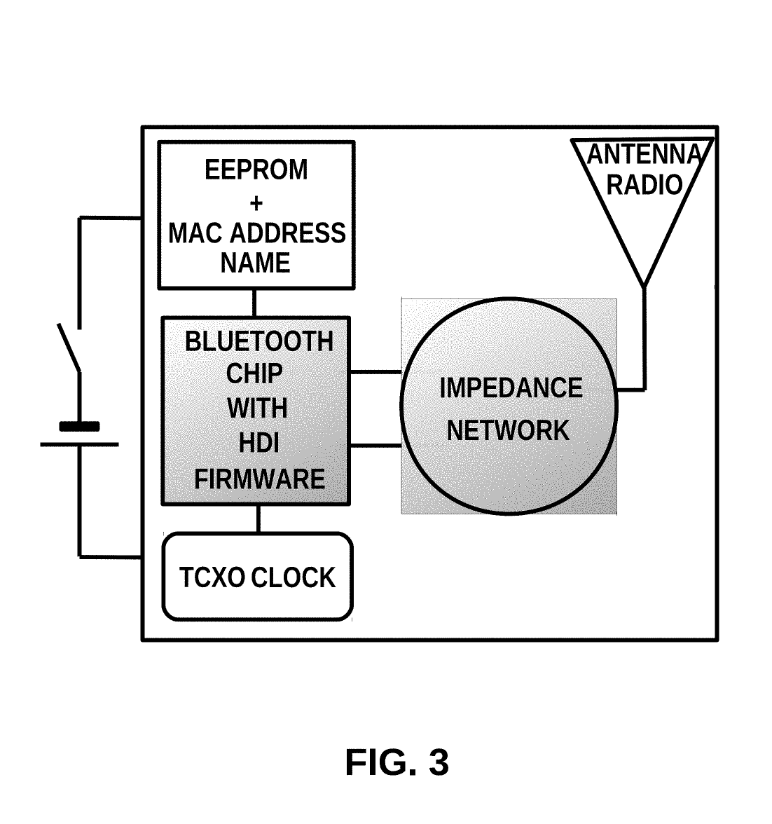

FIG. 3 is a schematic of a trigger device;

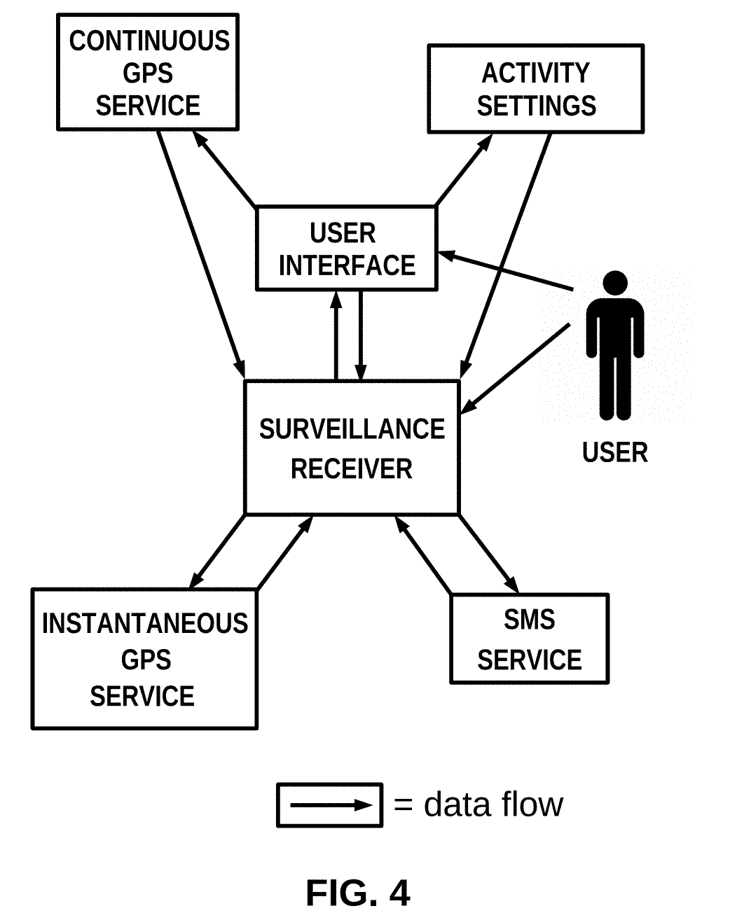

FIG. 4 is a bloc diagram of a mobile application, as installed on the mobile phone included in a system according to an embodiment of the invention, where each bloc represents a portion of code;

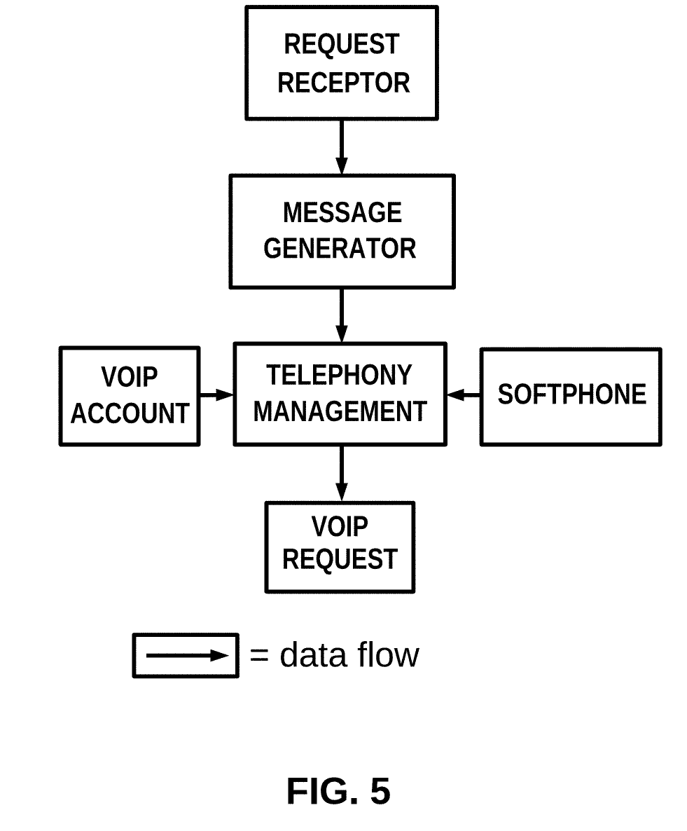

FIG. 5 is a bloc diagram of a server application, as installed on a call generating device included in a system according to an embodiment of the invention, where each bloc represents a portion of code.

The present invention relates to an emergency message transmission system. This type of message is sent by a user (1) wishing to inform or even alert an emergency contact by the means of the content of the message.

“Emergency contact” stands for an emergency service or a person.

The system comprises a triggering means (2) actionable by pressure or contact. In particular, the triggering means (2) comprises a button to be pressed or touched in order to trigger the transmission of an emergency message. Various types of triggering means will be discussed further. The emergency message is transmitted in particular by means of a mobile device (3) such as a mobile phone, preferably a smartphone, or tablet.

The system further comprises a mobile application (4) coordinated, but not necessarily connected, with the triggering means (2). The triggering means (2) is connectable to the mobile application (4), so that an action of a user (1) on the triggering means (2) triggers the application (4). In particular, the mobile application (4) is loaded into the memory of the mobile device (3) of a user (1), particularly a mobile phone.

According to an embodiment of the invention, the mobile application (4) is designed to transmit, in response to an activation of the triggering means (2), an emergency SMS message via a mobile network to an emergency device (5, 11). The mobile network is, in particular, of type GSM (for “Global System for Mobile Communication”).

Advantageously, the emergency message transmission system can be triggered quickly by contact or by pressure and uses a mobile network that does not require any Internet connectivity of the mobile device (3). Such system is both inexpensive and energy-saving. In addition, the triggering means (2) can be activated by a simple, fast, and discreet hand gesture of the user (1).

Advantageously, the system according to any embodiment of the invention does not require any the mobile device (3) to have any Internet connection in order to function, since the messages are directly sent via the mobile SMS network to the emergency device (5, 11). The system according to any embodiment of the invention is therefore functional wherever a mobile network can be accessed, and also does not require any kind Internet package or contract. Since emergency situations are not predictable, the system can be triggered at any time, providing that the mobile application (4) was previously activated.

The mobile application (4) and particularly the mobile device (3) of a user (1), comprise hardware elements and operating software modules known in themselves to those skilled in the art.

The invention relates to the integration of new functionalities in the mobile application (4) and to the interaction between known modules and modules of a system according to an embodiment of the invention, particularly those described herein. In particular, an alert module is configured to interact with an SMS message relay module via the mobile network for the transmission of alert messages.

The mobile device (3) of the user (1), in particular a smartphone, is registered on a mobile phone network via its SIM (for “Subscriber Identity Module”) card. The mobile device (3), in particular its SIM card, is associated with a telephone contract allowing it to send SMS messages via said network. The mobile device (3) is preferably equipped with a Bluetooth antenna. In addition, it is preferably equipped with a GPS antenna (for “Global Positioning System”) and or a Wi-Fi (for “Wireless Fidelity”) antenna.

The mobile application (4) is, in particular, preferably developed in object-oriented language. Said application is designed to generate text messages and send them by SMS service. Each user (1) can set and configure his or her mobile application as desired.

According to one embodiment of the invention, the emergency SMS message comprises personal data. In particular, the mobile application (4) integrates an interface module allowing each user (1) to store his or her personal data. The mobile application (4) is designed to include these personal data in the emergency SMS message which will subsequently be transmitted to the emergency device (5, 11).

In particular, a user (1) can, first of all, enter, for example using a touchscreen keyboard in dedicated interface fields of the mobile application (4), his or her personal data and or those of his or her emergency contacts, as well as their respective contact details. More particularly, the mobile application (4) comprises an interface module with, for example, a specific field to define an emergency text device (11) phone number, to which the emergency SMS messages must be sent, and an emergency voice device (8) phone number, which a call generating device (6) must call, then to which said generator must announce the voice message.

According to an alternate embodiment of the invention, the user can also enter, for example using a touchscreen keyboard in a free text zone, all the additional information that he or she considers relevant to subsequently communicate automatically, in the text and or voice messages sent by the system according to such embodiment of the invention.

According to an embodiment of the invention, the mobile application (4) comprises a geolocation module. In particular, when the mobile application (4) is installed on the mobile device (3) of a user (1), the geolocation module of the mobile application (4) interacts with the elements and or modules of the mobile device (3) to determine a geolocation of said device. This module thus makes enables to determine the geographic location of the user (1).

The geolocation providers (9) are generally the GPS satellite network and or the Wi-Fi networks nearby the mobile device (3). They typically provide geolocation in the form of geographic coordinates, including latitude and longitude, both in degrees, plus an altitude in meters. They can also indicate the accuracy of each geolocation, in meters.

Preferably, in order to geolocate the mobile device (3), the mobile application (4) contacts the geolocation providers (9). The mobile application (4) preferentially uses the GPS satellite network, which is generally the most accurate, and also available anywhere outdoors. Alternatively or in combination, for example should GPS signals be blocked by thick walls or ceilings, the mobile application (4) is able to retrieve the location of nearby Wi-Fi networks, which are self-located, via the Wi-Fi antenna of the mobile device (3), then deduces the geolocation of said device from this information.

The geolocation data collected by the mobile application (4) is included into the emergency SMS message, then transmitted to the emergency device (5, 11).

Advantageously, the SMS messages that the mobile device (3) of a user (1) sends via the mobile network can be automatically routed, without any connection to the Internet, to the closest emergency service to the user (1).

Preferably, the geolocation mode can be selected among the following three:
In a first mode, geolocation is inactive. This means that the mobile application (4) does not contact any geolocation provider. The generated text messages contain no geolocation data and are sent immediately, as soon as the user (1) activates the system.
In a second mode, geolocation is instantaneous. This means that the mobile application (4) only checks the location of the mobile device (3) when the user (1) activates the system. As soon as the mobile application (4) acquires the geolocation of the mobile device (3), it includes it in the text message generated, then sends it. The delay between activating the system and sending the messages varies, depending on the local physical topology. This can take up to 2 minutes. As for the mobile device (3), this mode is the most battery-saving geolocated mode, since it consumes no energy before of after the sendings.
In a third mode, geolocation is continuous. This means that the mobile application (4) regularly checks and updates the geolocation of the mobile device (3), for example every 10 seconds or every 20 meters. As a result, the application can, at any time, transmit a satisfactory approximation of the geolocation. Then, when the system is activated, the mobile application (4) generates and sends instantly a text message indicating the latest acquired geolocation. This mode is more energy consuming than the other geolocated mode, but is more responsive.

In any active geolocated mode, in case the mobile device (3) is connected to the Internet, the mobile application (4) is designed to convert the geolocation coordinates into a street address and to include it into the emergency SMS message sent. In particular, the mobile application (4) obtains a street address by using geolocation data made available on the Internet.

According to an embodiment illustrated by FIG. 2, the graphical interface of the mobile application (4) preferably integrates a call button. This button can be used as a triggering means (2), that activates the system. In particular, pressure or contact on said button causes the mobile device (3) to generate and send an emergency SMS. This embodiment is energy-saving because such triggering means doesn't require any extra energy to activate the application.

Alternatively or in combination, according to an embodiment illustrated by FIG. 1, the triggering means (2) comprises, and possibly consists of, a trigger device. The trigger device (2) is, in particular, a device external to the mobile device (3) of the user (1). A device similar to a digital camera trigger can be used, but the simplified trigger detailed below is preferred. Advantageously, such trigger device (2) can be activated by a simple, fast, and discreet hand gesture of a user (1), without even having to grab his mobile device (3).

The trigger device (2) is able to connect to the mobile device (3) of a user (1), in particular via a wireless connection, such as a Bluetooth. The connection enables the trigger device (2) to interact with the mobile application (4).

The trigger device (2) is for example a Bluetooth HID (for “Human Input Device”) device that can be devoid of any user input buttons. Its activation can then be made by just powering it up, using an electric switch:

The source of the Bluetooth chip of the trigger device (2) signal is an EEPROM (for “Electrically Erasable Programmable Read-Only Memory”), which contains the identity of the trigger device (2). Once powered up, the trigger device (2) emits its identity, which is sufficient for such device to be detected by the mobile device (3), with which it had already been paired previously. This detection then activates the system and the method according to the invention. Hence, one can consider that such trigger device (2) has been functionally activated.

Advantageously, this activation by an electrical switch allows a trigger device (2) consisting of few components, hence inexpensive and easy to miniaturize.

The trigger device (2) electrical circuit can therefore include:
an EEPROM chip;
a Bluetooth chip, preferably with integrated firmware;
an oscillator, for example a temperature-compensated quartz oscillator;
an RF (for “Radio Frequencies”) antenna, preferably of type PCB (for “Printed Circuit Board”);
preferably an impedance network;
an electrical feed, preferably a button cell battery; and
preferably a electrical switch.

The EEPROM chip embeds the identity of the trigger device (2). This identity can comprise one or two data: the MAC (for “Media Access Control”) address of the trigger device (2), and preferably its name.

The Bluetooth chip may embed a HID firmware. This firmware allows the trigger device (2) to pair with the mobile device (3) of a user (1). The Bluetooth chip may possibly comply with Bluetooth standard 2.1.

The oscillator can be used as a clock for the electrical the circuit of the trigger device (2).

The RF antenna emits said identity nearby the trigger device (2). With Bluetooth 2.1, for example, this antenna emits within a radius of 10 meters.

The impedance network allows to optimize the electrical efficiency of the circuit of the trigger device (2).

The button cell battery is the preferred power supply for the electrical circuit of the trigger device (2), in particular to gain space and make the trigger device (2) portable.

The switch is used to connect or disconnect electrically the button cell battery, thus activating or inactivating the trigger device (2).

The emergency text device (11) may be a telephone, in particular the smartphone of an emergency contact. More particularly, the emergency text device (11) is for example the phone of a contact to whom the user (1) wishes to send emergency SMS messages. These are usually mobile phone lines.

However, these emergency text devices (11) may also be landlines, in cases where the telephony provider of such lines also features the conversion of SMS messages into voice messages.

Alternatively or in combination, the emergency device may be an emergency relay device (5) configured to forward the information of the emergency SMS message to another device. The emergency relay device (5) is, for example, a smartphone capable of receiving SMS messages. The emergency relay device (5) can also be a special, particularly a short, phone number service that can be contacted by SMS.

According to an embodiment of the invention that can be illustrated by FIG. 2, the system further comprises a call generating device (6) connected to the emergency relay device (5). The connection is configured to transmit the information contained in each emergency SMS message. Preferably, said information is transmitted to the call generating device (6).

Advantageously, the call generating device (6) integrates a device dedicated to the synthesis of voice messages, using a specific storage space, without having to use the resources of the mobile device (3).

In particular, the emergency relay device (5) is configured to forward the data of each SMS message that it receives, as sent by the mobile application (4), to the call generating device (6).

It is also possible to consider an embodiment in which the emergency relay device (5) comprises a network card connecting it to a computer which integrates the call generating device (6).

In particular, the emergency relay device (5) is connected to the call generating device (6) over the Internet. Alternatively or in combination, the emergency relay device (5) can be connected to the call generating device (6) via Wi-Fi. The emergency relay device (5) is configured to transmit the content of the SMS messages it receives to the call generating device (6) in the form of an HTTP (for “Hyper Text Transfer Protocol”) request, for example via Wi-Fi. The call generating device (6) is configured to generate an emergency voice message corresponding to the emergency SMS message. In particular, the emergency SMS message is converted into an emergency voice message. In addition, the call generating device (6) is configured to initiate a phone call and to announce the said emergency voice message via the line contacted.

Advantageously, the system according to this embodiment allows a vocalized communication with the emergency contact, which is more efficient then an SMS alert message. Indeed, the system allows to contact indifferently a emergency landline (8) or a mobile line (8), in a relevant and efficient manner.

More particularly, the call generating device (6) may call police stations, particularly the local ones, hospitals, or fire stations. In regions where the official emergency services have an SMS number, said generator can also contact them via SMS.

The call generating device (6) comprises hardware elements and operating software modules, some of which are known in themselves to those skilled in the art. In particular, the call generating device (6) preferably comprises a server running a server application (7). The call generating device (6) is for example a server connected to the Internet, also previously configured as a Wi-Fi access point, in an embodiment where the emergency relay device (5) consists of a smartphone.

The server application (7) is, for example, an application developed in an object-oriented language, and is installed on the call generating device (6). Preferably, the server application (7) communicates particularly with a VOIP (for “Voice over Internet Protocol”) provider, as a client of such provider. The server application (7) preferably also integrates the softphone functionality.

In particular, the call generating device (6) comprises a voice synthesis module configured to generate a voice message from the data of the emergency SMS message. It is more particularly a sub-module of the server application (7). The voice message generated is preferably stored in the call generating device (6) in the form of a sound file.

The call initiated by the call generating device (6) is addressed to the emergency landline (8) or emergency mobile line (8) which is associated to a contact that the user (1) wishes to solicit with said voice message, in case of an emergency.

According to one embodiment, the call generating device (6) is configured to directly or indirectly convert the geolocation data into a street address. For example, the emergency SMS message may include location data, in the form of GPS coordinates or some other form. Such data is converted into a street address by the call generating device (6), then, in particular, integrated into the emergency voice message.

The call generating device (6) may connect to a Web Map Service (10), able to convert geographic coordinates into street addresses, consisting of a street name and number, a postal code and a city. The call generating device (6) may send the location data to said service and thus retrieve a street address therefrom.

The invention further relates to an emergency message transmission kit comprising a mobile application (4) and a triggering means (2), in particular a trigger device, of a system as described above.

An example of use will now be detailed. For the embodiment with a trigger device as triggering means (2), the user (1) connects the trigger device (2) to his or her smartphone (3) beforehand. In particular, the user activates the trigger device (2) before pairing it to the smartphone (3), particularly using the graphical user interface for the Bluetooth management of the smartphone (3). In particular, in an embodiment where the trigger device (2) is a Bluetooth HID, pairing is made automatically on said device side.

The user (1) then deactivates the trigger device (2). Then or beforehand, the user (1) installs the mobile application (4) on the smartphone (3). The user (1) can install said application using its installation file, as loaded on the smartphone (3) for example via USB (for “Universal Serial Bus”), or by downloading it via the Internet.

The mobile application (4) is henceforth active, and is preferably kept active permanently, for example as a background process of the smartphone (3). Thus, there is no need to turn it on or off, since it consumes almost no energy, except when the user (1) selects the continuous geolocation mode. The mobile application (4) will thus be able to respond at any moment to an activation, by the user (1), of the system according to this embodiment of the invention.

The user (1) can then configure the mobile application (4) and customize it at his or her convenience, in order to use the system according to the invention as efficiently as possible.

Subsequently, when the user (1) decides to activate the system according to this embodiment of the invention, he or she activates the trigger device (2), for example, by toggling the electrical switch of said device. The trigger device (2) then emits, in a few seconds, for example in 5 seconds, its identity, thus signaling its presence all around.

If it is close enough to the trigger device (2), the smartphone (3) instantly detects its presence, since they have already been previously paired. The smartphone (3) then becomes automatically and instantly the host of a Bluetooth connection with the trigger device (2).

The mobile application (4), as permanently active, instantly detects this connection and starts generating the text messages according to the configuration and the personal parameters defined by the user (1).

In any case, the generated text messages preferably contain the personal data of the user (1) as well as these of the contact telephone line (8 or 11) to solicit.

Preferably, they also automatically contain all the additional information that the user (1) has previously entered.

The rest of the content of the text messages, as well as the modalities of their sending, depends on the geolocation mode that the user (1) selected. In case of an active geolocation mode (instantaneous or continuous), the geolocation of the smartphone (3), as well as the accuracy of said geolocation, will preferably also be indicated in the text messages.

In order to geolocate the smartphone (3), the mobile application (4) contacts the geolocation providers (9). It uses preferentially the GPS satellites network, which is generally the most accurate, and available everywhere outdoors. However, indoors, GPS might be hidden by thick walls or ceilings. Then, the mobile application (4) asks surrounding Wi-Fi networks their known location, via the Wi-Fi antenna of the smartphone (3), and deduces the geolocation of the mobile device (3) from this information.

The mobile application (4) then sends the text messages by SMS to the emergency relay device (5) and to the emergency text device (11).

As soon as it receives the text message that the mobile application (4) has sent by SMS, the emergency relay device (5) automatically forwards its content to the call generating device (6) by embedding it inside a HTTP request made to the server application (7) of the call generating device (6).

The server application (7) then processes the text message embedded in the received HTTP request in the order below:

If the text message contains geolocation data, the server application (7) converts the geographical coordinates into a street address using a Web Map Service (10), with which it communicates via HTTP.

The server application (7) converts the text message obtained into a voice message, by using the voice synthesizer installed on the call generating device (6), and stores this voice message as a sound file.

The server application (7) initiates a VOIP phone call to the emergency telephone line (8). To do so, said application connects to its VOIP provider using its integrated softphone. In particular, the VOIP call is of type SIP (for “Session Initiation Protocol”), and the softphone is set in media transfer mode, where the medium transferred is the sound file of the voice message.

Then, as soon as the emergency contact answers this call made on the emergency telephone line (8), said softphone announces, through this line, the voice message to this emergency contact.

Preferably, once activated, the system re-triggers itself automatically and regularly for a predetermined period, for example every 5 or 30 minutes, updating every time, when applicable, the geolocation of the smartphone (3). In particular, this reactivation is initiated by the mobile application (4). To interrupt this triggering routine, the user (1) can either press a cancel button integrated in the graphical interface of the mobile application (4), or toggle the electrical switch of the trigger device (2), which turns it off, thus disconnecting it from the smartphone (3).

Preferably, the mobile application (4) detects this disconnection immediately and terminates the triggering routine at once.

The graphical interface of the mobile application (4) preferably displays a call button. Should a user (1) be unable to use the trigger device (2), said user can activate the system by pressing this button. This simulates the activation of the trigger device (2), thus activating the system according to such embodiment. This constitutes another embodiment of the invention, in combination or alternative to the embodiment using a trigger device (2).

The systems according to any embodiment of the invention can operate identically on a tablet (3), instead of a smartphone (3), provided that said tablet features all the functionalities required for the method of the invention.

As it is notably able to call directly the police, emergency medical services or fire stations, the system according to the invention allows to ask effectively and instantly for help, in any emergency situation. For example, it is most relevant for any kind of assault, fainting fits, any kind of accident, notably of elderly persons, or fire outbreaks, or hold-ups . . . .

As it requires only the registering of users (1) to the GSM network, it enables to secure large areas.

The growing feeling of insecurity, the large number of assaults, especially sexual, and the aging of populations make the system according to the invention of major interest.

In addition, the simplicity of the electronics needed makes it a most affordable solution.

1. An emergency message transmission system, including:
a triggering means (2) activated by pressure or contact,
a mobile application (4), designed to be installed on a mobile device (3), and cooperating with the triggering means (2), also configured to transmit, in response to an activation of the triggering means (2), an emergency SMS message via a mobile network, in particular GSM, to an emergency relay device (5) and/or an emergency text device (11),
wherein the improvement comprises:
an emergency relay device (5), and
a call generating device (6) connected to the emergency relay device (5), the call generating device (6) being configured to produce an emergency voice message corresponding to the emergency SMS message transmitted by the emergency relay device (5), then initiate a phone call to the emergency voice device (8) of an emergency contact and announce to said emergency voice message to said contact.

2. A system of claim 1, wherein the mobile application (4) comprises a geolocation module and the emergency SMS message comprises geolocation data.

3. A system of claim 1 or 2, wherein the SMS emergency message comprises personal data.

4. A system of any of claims 1 through 3, wherein the mobile application (4) comprises a module for defining the number of said emergency text device (11).

5. A system of any of claims 1 through 4, wherein the mobile application (4) comprises a module for defining the number of said emergency voice device (8).

6. A system of any of claims 1 through 5, wherein the triggering means (2) comprises a trigger device, connectable, in particular via Bluetooth, to the mobile device (3) comprising the mobile application (4).

7. A system of claim 6, wherein the trigger device (2) is activated by powering it up electrically.

8. A system of any of claims 1 through 7, wherein the mobile application (4) and/or the call generating device (6) is configured to convert the geolocation data into a street address.

9. A system of any of claims 1 through 8, wherein the triggering means (2) comprises a button included in the graphical interface of the mobile application (4).

10. An emergency message transmission kit, comprising a mobile application (4) of any of claims 1 through 9 and the triggering means (2) of the very same claim.

11. A method of transmitting an emergency message by means of any of claims 1 through 10, comprising the following steps:
trigger the generation of an emergency message by pressure or contact,
transmit, in response to said step of triggering, the emergency SMS message via a mobile network, in particular GSM, to an emergency device (5, 11),
produce an emergency voice message corresponding to the emergency SMS message transmitted by the emergency relay device (5),
initiate a phone call to the emergency voice device (8), and
announce said emergency voice message to an emergency contact when said contact picks up the emergency voice device (8).

12. A method of claim 11, further comprising a step of geolocating a user, and introducing geolocation data into the emergency SMS message.

13. A method of claim 11 or 12, further comprising a step of converting the geolocation data into a street address.

14. A method of any of claims 11 through 13, further comprising a step of including personal data of the user (1) into the emergency SMS message.

15. A computer program product, in particular a mobile application and/or a server application, loadable in the memory of at least one electronic device, in particular a mobile device and/or a call generating device, comprising software code portions designed to carry out the steps of a method of claims 11 through 14.
